(19) United States
(12) Patent Application Publication
(10) Pub. No.: US 2004/0184777 A1
(43) Pub. Date: Sep. 23, 2004

(54) Method for detecting overlap of scheduled recording times

(75) Inventor: Kyoung Soo Moon, Seoul (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/804,426

(22) Filed: Mar. 18, 2004

(30) Foreign Application Priority Data
Mar. 19, 2003 (KR) 17091/2003

(51) Int. Cl. H04N 5/76; G06F 3/00; G06F 13/00

(52) U.S. Cl. 386/83; 725/58

(57) ABSTRACT

The present invention relates to a method for detecting an overlap of scheduled recording times. In the method for detecting an overlap of scheduled recording times according to the present invention, if there exists any broadcasting program scheduled to record, scheduled recording times of the broadcasting programs reserved to record are corrected on the basis of calculated time correction data for channels. Then, it is determined whether the scheduled recording times of the broadcasting programs overlap. If the scheduled recording times of the broadcasting programs overlap, information on the overlap is reported to a user.

### BACKGROUND OF THE INVENTION

1. Field of the Invention

The present invention relates to a schedule recording apparatus, and more particularly, to a method for detecting overlap of scheduled recording times.

2. Description of the Related Art

Digital broadcast is a common name of all the broadcasts that are digitally transmitted. Generally, a stream transmitted as a digital broadcast can carry data information as well as a video/audio signal.

The data broadcast for the data information allows an audience to obtain additional information on a broadcasting program, purchase goods, search for interesting information on weather, share, news, etc., and use a banking service by simple manipulation at home during his or her watching a television set. In addition, the audience can make an active participation in a broadcasting program. For example, the audience can participate in a live quiz show program to win a prize according to his or her obtained points, give an account for news, or reflect his or her opinion to a broadcasting program.

Accordingly, the digital broadcast can provide various data information besides video and audio provided by the conventional analogue broadcast.

The digital broadcast can provides the above-mentioned various services by transmitting various additional information through a broadcasting program and system information protocol (PSIP) in contrast to the conventional analogue broadcast.

This PSIP information includes a system time table (STT) containing base time (BT). Accordingly, when a user commands a recorder to reserve and record a broadcasting program, the recorder sets a schedule recording time including a record start time and a record end time of the broadcasting program with reference to base time of a channel that will provide the broadcasting program.

Meanwhile, there exists a small difference in base time between the channels of broadcast stations that provide a plurality of broadcast programs because of technical reasons of each broadcast station. For example, even if all the base times are set to be 10 o'clock, the base times of first, second, and third channels may be 10:00, 10:03 and 10:10 respectively because of the technical reasons of each broadcast station.

In this case, when the user intends to reserve and record broadcasting programs transmitted from the different channels, the scheduled recording times for some of the broadcasting programs may be overlapped with each other. Here, a broadcasting program of a channel cannot be reserved and recorded, the scheduled recording time of which is between the record start time and the record end time of a broadcasting program of another channel.

Of course, a broadcasting program of a channel can be scheduled-recorded, the scheduled recording time of which does not overlap with the scheduled recording time of a broadcasting program of another channel.

For example, however, assuming that a first broadcasting program of a first channel, which starts at 8:30 (record start time) and ends at 10:00 (record end time), is scheduled-recorded (i.e. first scheduled recording time) while a second broadcasting program of a second channel, which starts at 10:00 (record start time) and ends at 11:00 (record end time), is scheduled-recorded (i.e. second scheduled recording time).

Here, the first and second scheduled recording times are set based on the base times of the corresponding channels.

Accordingly, if the base times of the corresponding channels are a little different from each other, the first scheduled recording time of the first channel and the second scheduled recording time of the second channel may overlap. In other words, actually, the first broadcasting program of the first channel may start at 8:40 and end at 10:10 while the second broadcasting program of the second channel starts at 10:00 and ends at 11:00. Therefore, the first and second broadcasting programs overlap from 10:00 to 10:10 so that none of broadcasting programs cannot be reserved and recorded during the period from 10:00 to 10:10.

### SUMMARY OF THE INVENTION

Accordingly, the present invention is directed to a method for detecting an overlap of scheduled recording times, which substantially obviates one or more problems due to limitations and disadvantages of the related art.

An object of the present invention is to provide a method for detecting an overlap of the scheduled recording times of broadcasting programs caused by a difference between base times of the corresponding channels.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for detecting an overlap of scheduled recording times includes the steps of: (a) ascertaining whether there exists any broadcasting program reserved to record; (b) if there exists any broadcasting program scheduled to record, correcting a scheduled recording time of the broadcasting program scheduled to record on the basis of calculated time correction data for channels; (c) determining whether or not the scheduled recording times of the broadcasting programs overlap; and (d) if the scheduled recording times of the broadcasting programs overlap, reporting information on the overlap.

The method for detecting an overlap of scheduled recording times may further include the step of: (e) before the step (a), when a power is turned on, calculating the time correction data for the channels.

The step (e) may include the steps of: setting, as a reference time, a base time provided from a reference channel tuned first when the power is turned on; obtaining base times provided from remaining channels excepting for the reference channel; and calculating the time correction data for the channels by using the reference time and the base times.

It is desirable that the calculated time correction data are time differences between the reference time and the base times of the remaining channels.

The step (b) may includes the steps of: reading the time correction data of the channels corresponding to the broadcasting programs reserved to record among the calculated time correction data of the channels; and adding the read time correction data to the scheduled recording times of the broadcasting programs scheduled to record.

In another aspect of the present invention, a method for detecting an overlap of scheduled recording times includes the steps of: (a) when a power is turned on, calculating time correction data for channels; (b) if there exists any broadcasting program reserved to record, correcting a scheduled recording time of the broadcasting program reserved to record on the basis of calculated time correction data for the channels; (c) determining whether the corrected scheduled recording times of the broadcasting programs overlap; and (d) if the scheduled recording times of the broadcasting programs overlap, reporting information on the overlap.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart of a method for detecting an overlap of scheduled recording times according to a preferred embodiment of the present invention;

FIG. 2 is a flowchart of a method for calculating time correction data shown in FIG. 1; and

FIG. 3 illustrates that broadcasting programs reserved to record by the method for detecting an overlap of scheduled recording times according to a preferred embodiment of the present invention overlap.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

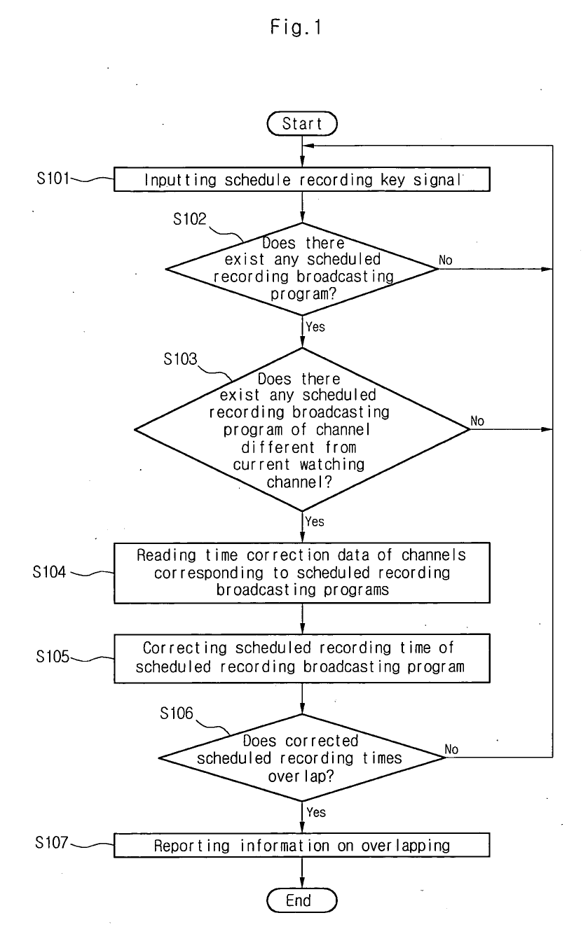

FIG. 1 is a flowchart of a method for detecting an overlap of scheduled recording times according to a preferred embodiment of the present invention.

Referring to FIG. 1, in a method for detecting an overlap of scheduled recording times according to a preferred embodiment of the present invention, when a schedule recording key signal is inputted to record a broadcasting program (S101), it is ascertained whether there exists any broadcasting program scheduled to record (hereinafter, referred to as scheduled recording broadcasting program) (S102). Here, the schedule recording key signal is a signal used to detect the overlap of the scheduled recording times of the scheduled recording broadcasting programs. Accordingly, it is supposed that at least one broadcasting program provided at least one channel was reserved to record.

If there no exists a scheduled recording broadcasting program, a user can reserve his or her wished broadcasting programs for recording by additional key manipulation.

If there exists any scheduled recording broadcasting program, it is ascertained whether there exists any scheduled recording broadcasting program of a channel that is different from the channel the broadcasting program of which the user is watching (hereinafter, referred to as current watching channel) (S103).

Here, if there no exists a scheduled recording broadcasting program of a channel that is different from the current watching channel, the user can reserve and record his or her wished broadcasting programs by additional key manipulation.

If there exists any scheduled recording broadcasting program of a channel that is different from the current watching channel, the time correction data of the channels corresponding to the scheduled recording broadcasting programs are read among the calculated time correction data of each channel stored in a channel map (S104). Here, the time correction data were calculated for each channel and stored beforehand. The method of calculating the time correction data will be described in detail later.

A scheduled recording time of the scheduled recording broadcasting program is corrected on the basis of the time correction data for channels (S105).

In other words, as described above, since the time correction data are calculated for each channel, the scheduled recording times of the scheduled recording broadcasting programs are corrected on the basis of the time correction data for channels corresponding to the scheduled recording broadcasting programs.

For example, the first time correction data of the first channel can be added to the scheduled recording time, that is, the record start time and the record end time of the first scheduled recording broadcasting program. The second time correction data of the second channel can be added to the scheduled recording time of the second scheduled recording broadcasting program. The third time correction data of the third channel can be added to the scheduled recording time of the third scheduled recording broadcasting program.

The above-mentioned adding correction method is merely an example and various modifications can be made, for example, any one selected from four arithmetic operations such as addition, subtraction, multiplication and division.

It is determined whether the corrected scheduled recording times of the scheduled recording broadcasting programs overlap (S106).

Here, it is desirable that the determination of the overlap is performed using the corrected scheduled recording times.

In other words, by comparing the scheduled recording time (record start time and record end time) of the first scheduled recording broadcasting program with the scheduled recording time (record start time and record end time) of the second scheduled recording broadcasting program, it can be determined whether the scheduled recording time of the first scheduled recording broadcasting program is overlapped with the scheduled recording time of the second scheduled recording broadcasting program. Of course, by using the scheduled recording times of other scheduled recording broadcasting programs, it can be ascertained whether the scheduled recording times of other scheduled recording broadcasting programs overlap.

Accordingly, through the above-mentioned process, the overlap of the scheduled recording broadcasting programs can be detected in advance.

If the scheduled recording times of the scheduled recording broadcasting programs overlap, information on the overlap is reported to a user in the form of message or voice (S107).

As described above, in the present invention, since scheduled recording time of each scheduled recording broadcasting program is corrected using calculated time correction data, the overlap of the scheduled recording broadcasting programs caused by a small difference between the base times of channels can be detected.

The method for calculating the time correction data read at the step S104 will be described.

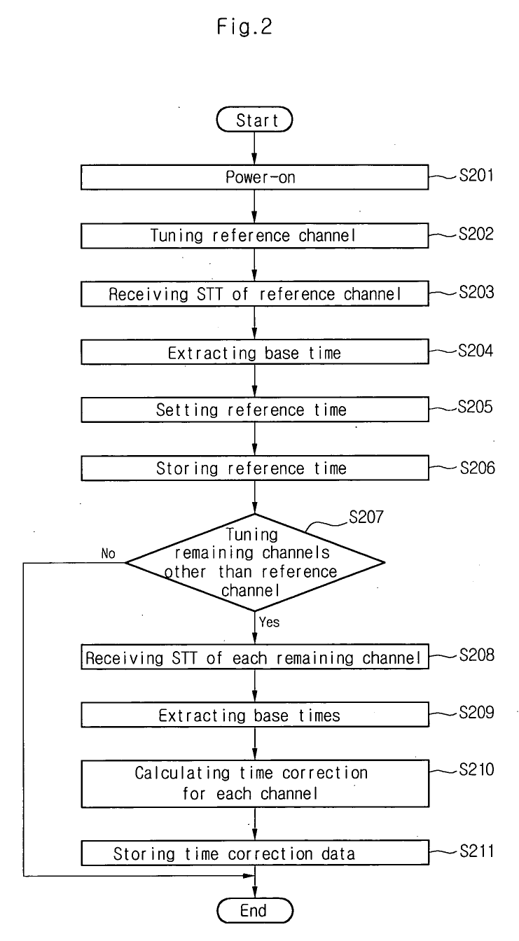

FIG. 2 is a flowchart of a method for calculating time correction data shown in FIG. 1.

Referring to FIG. 2, in the method for calculating the time correction data according to the present invention, an apparatus such as a scheduled recording apparatus (a recorder to reserve and record a broadcasting program) or a television set is turned on (S201).

When the apparatus is turned on, a reference channel set in default by a user is tuned (S202).

Here, system time table provided through the reference channel is received from a corresponding broadcast station (S203)

The base time of the reference channel is extracted from the received system time table (S204).

The extracted base time is set to be a reference time used to synchronize base times of other channels (S205). The set reference time is stored in a channel map (S206).

Accordingly, the channel tuned first when the power is turned on is preferably set to be a reference channel having a reference time. In the present invention, the channel set in default is set to be a reference channel but the reference channel can be set variously.

Meanwhile, if the base time of the reference channel is set to be a reference time and stored in the channel map, it is ascertained whether the remaining channels excepting for the reference channel are tuned (S207).

Generally, when the corresponding apparatus is turned on, since the remaining channels as well as the reference channel set in default are tuned, the step S207 can be omitted.

As the result of the ascertainment, if the remaining channels are tuned, the system time tables of the remaining channels are received from the broadcast stations corresponding to the remaining channels (S208).

The base times are extracted from the system time tables of the remaining channels and the extracted base times are stored in the channel map (S209).

Accordingly, the channel map contains the reference time of the reference channel and the base times of the remaining channels.

Here, the time correction data for the channels are calculated using the reference time for the reference channel and the base times for the remaining channels that are stored in the channel map (S210).

The time correction data can be calculated using any one of four arithmetic operations such as addition, subtraction, multiplication and division. In the present invention, the result values (i.e. time difference) obtained by subtracting the base times of the remaining channels from the reference time of the reference channel are used as the time correction data for each channel.

The method of calculating the time correction data will be described in detail.

For example, supposing that the base time of the first tuned channel, that is, the reference time of the reference channel is T1 and then the base times of the next sequentially tuned channels are T2, T3, T4, . . . , and TN respectively, the reference time T1 of the reference channel and the base times T2, T3, T4, . . . , and TN of the remaining channels are defined as follows:

T1=the base time of the first tuned channel;

T2=the base time of the second tuned channel;

T3=the base time of the third tuned channel; . . . ; and

TN=the base time of the N-th tuned channel.

When the reference time T1 of the reference channel and the base times T2, T3, T4, . . . , and TN of the remaining channels are applied to the subtraction method, the correction time data G1, G2, . . . , and GN for the channels are calculated as follows:

G1=0;

G2=T1+G1−T2=T1−T2;

G3=T2+G2−T3=T2+(T1−T2)−T3=T1−T3; . . . ; and

GN=TN-1+GN-1−TN=T1−TN,

where G is time difference between the base time of the reference channel and the base time of the corresponding channel.

Accordingly, even though the base time T1 of the reference channel is not stored separately, if the base time T of a previous channel and the time difference G are known, the time difference between T1 and the base time of each channel can always be calculated.

Therefore, summarizing the above-mentioned, the following equation can be made.

TN=the base time BT extracted from the system time table STT of the N-th tuned channel.

GN=the base time TN-1 of the N-1-th tuned channel+the time difference GN-1 of the N-1-th tuned channel−the base time TN of the N-th tuned channel.

The calculated time correction data for channels are mapped to the corresponding channels in one-to-one mapping and stored in the channel map (S211).

Accordingly, the scheduled recording times of the scheduled recording broadcasting programs are corrected using time correction data of each channel stored in the channel map so that it is easy to detect the overlap of the scheduled recording broadcasting programs.

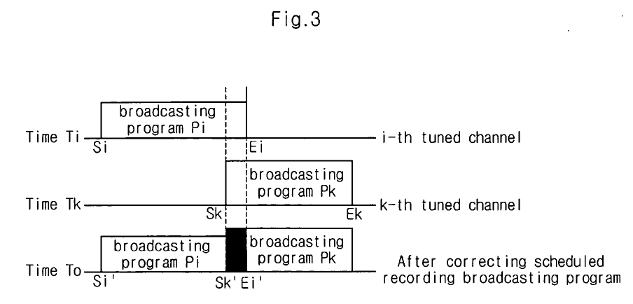

FIG. 3 illustrates that broadcasting programs reserved to record by the method for detecting an overlap of scheduled recording times according to a preferred embodiment of the present invention overlap.

Referring to FIG. 3, a broadcasting program Pi of an i-th tuned channel and a broadcasting program Pk of a k-th tuned channel are reserved to record respectively. Here, suppose that the broadcasting program Pi has a scheduled recording time consisting of a record start time Si of 10 o'clock and a record end time Ei of 11 o'clock and the broadcasting program Pk has a scheduled recording time consisting of a record start time Sk of 11 o'clock and a record end time Ek of 12 o'clock. Here, it is assumed that the time correction data of the broadcasting program Pi and the broadcasting program Pk are Gi=10 and Gk=0 respectively. Here, the time correction data are obtained by synchronizing the base times of the i-th and k-th tuned channels with the reference time of the reference channel respectively.

Accordingly, the broadcasting program Pi should be recorded from 10 o'clock to 11 o'clock and the broadcasting program Pk should be recorded from 11 o'clock to 12 o'clock.

However, since the base times of the i-th and k-th tuned channels are a little different from each other, the time correction data are Gi=10 and Gk=0 as assumed above.

Accordingly, the time correction data are added to the scheduled recording times of the broadcasting programs Pi and Pk respectively so that the scheduled recording times of the broadcasting programs Pi and Pk are corrected respectively as follows.

The scheduled recording time of the broadcasting program Pi is corrected to have the record start time Si′ of 10:10 and the record end time Ei′ of 11:10, and the scheduled recording time of the broadcasting program Pk is corrected to have the record start time Sk′ of 11:00 and the record end Ek′ time of 12:00.

As described above, scheduled recording times of the scheduled recording broadcasting programs are corrected using time correction data for each channel calculated with reference to a reference time of a reference channel, whereby the overlap of the scheduled recording broadcasting programs caused by the small difference between base times of the channels can be detected.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for detecting an overlap of scheduled recording times, the method comprising the steps of:
(a) ascertaining whether there exists any broadcasting program reserved to record;
(b) if there exists any broadcasting program scheduled to record, correcting a scheduled recording time of the broadcasting program reserved to record on the basis of calculated time correction data for channels;
(c) determining whether the scheduled recording times of the broadcasting programs overlap; and
(d) if the scheduled recording times of the broadcasting programs overlap, reporting information on the overlap.

2. The method according to claim 1, further comprising the step of:
(e) before the step (a), when a power is turned on, calculating the time correction data for the channels.

3. The method according to claim 2, wherein the step (e) comprises the steps of:
setting, as a reference time, a base time provided from a reference channel tuned first when the power is turned on;
obtaining base times provided from remaining channels excepting for the reference channel; and
calculating the time correction data for the channels by using the reference time and the base times.

4. The method according to claim 3, wherein the step (e) further comprises the steps of:
mapping the calculated time correction data to corresponding channels in one-to-one mapping and storing the mapped time correction data.

5. The method according to claim 3, wherein the reference channel is set in default by a user.

6. The method according to claim 3, wherein the step (e) further comprises the steps of:
storing the set reference time and the base times provided from the remaining channels excepting for the reference channel.

7. The method according to claim 3, wherein the calculated time correction data are time differences between the reference time and the base times of the remaining channels.

8. The method according to claim 1, wherein the scheduled recording time includes a record start time and a record end time.

9. The method according to claim 1, wherein the step (b) comprises the steps of:
reading the time correction data of the channels corresponding to the broadcasting programs reserved to record among the calculated time correction data of the channels; and
adding the read time correction data to the scheduled recording times of the broadcasting programs scheduled to record.

10. The method according to claim 1, wherein the information on the overlap is reported in the form of message or voice.

11. A method for detecting an overlap of scheduled recording times, the method comprising the steps of:
(a) when a power is turned on, calculating time correction data for channels;
(b) if there exists any broadcasting program scheduled to record, correcting a scheduled recording time of the broadcasting program reserved to record on the basis of calculated time correction data for the channels;
(c) determining whether the corrected scheduled recording times of the broadcasting programs overlap; and
(d) if the scheduled recording times of the broadcasting programs overlap, reporting information on the overlap.

12. The method according to claim 11, wherein the step (a) comprises the steps of:
setting, as a reference time, a base time provided from a reference channel tuned first when the power is turned on;
obtaining base times provided from remaining channels excepting for the reference channel; and
calculating the time correction data for the channels by using the reference time and the base times.

13. The method according to claim 12, wherein the reference channel is set in default by a user.

14. The method according to claim 11, wherein the calculated time correction data are time differences between the reference time and the base times of the remaining channels.

15. The method according to claim 11, wherein the step (b) comprises the steps of:
reading the time correction data of the channels corresponding to the broadcasting programs reserved to record among the calculated time correction data of the channels; and
adding the read time correction data to the scheduled recording times of the broadcasting programs reserved to record.
